(19) United States
(12) Patent Application Publication
(10) Pub. No.: US 2008/0084643 A1
(43) Pub. Date: Apr. 10, 2008

(54) Method For Regulating A Converter Connected To Dc Voltage Source

(75) Inventors: Jorg Flottemesch, Bubenreuth (DE); Michael Weinhold, Erlangen (DE); Rainer Zurowski, Forchheim (DE)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 11/631,987

(22) PCT Filed: Jul. 4, 2005
(86) PCT No.: PCT/EP05/53177

§ 371 Date: Jan. 9, 2007

(30) Foreign Application Priority Data
Jul. 9, 2004 (DE) 10 2004 034 333.0

(51) Int. Cl. H02H 9/02

(52) U.S. Cl. 361/93.2

(57) ABSTRACT

A method for controlling a static converter connected to a direct-current source. The converter has power conductor switches that can be deactivated and is configured to supply a distribution network with three-phase voltage. The currents flowing through the respective power semiconductor switches are measured, current values respectively assigned to the power semiconductor switches are obtained, the current values are sampled and digitized to obtain digital current values. The latter are checked by a logic in a control unit for the presence of an excess current condition. If no excess current condition is detected, the power semiconductor switches are activated and deactivated with the aid of a nominal operation controller and if an excess current condition is detected, at least the power semiconductor switches with assigned digital current values that fulfill the excess current condition are deactivated after a pulse block has expired. For the digital current values that fulfill the excess current condition, all power semiconductor switches, which are connected to the positive direct-current terminal, are activated and all power semiconductor switches, which are connected to the negative direct-current terminal are deactivated or vice versa. For the digital current values that do not fulfill the excess current condition, the power semiconductor switches are controlled once again by the nominal operation controller.

The invention relates to a method for regulating a converter, which is connected to a DC voltage source, with power semiconductor switches which can be switched off, which converter is provided for feeding a distribution network with three-phase voltage.

Methods for regulating converters using a DC voltage are known, for example, from HVDC transmission. HVDC transmission is used, firstly, for transmitting electrical energy over long distances. Another application relates to the coupling of networks which have, for example, a different three-phase voltage frequency. For HVDC transmission, two converters are connected to one another via a DC circuit or a DC voltage intermediate circuit. The converters are each connected to a three-phase voltage network and essentially comprise power semiconductor switches. Self-commutated converters, i.e. converters with self-commutated power semiconductor switches, are used to an increased extent in network coupling. This applies in particular to the coupling of an island network to a supply network. Island networks do not have any significant dedicated current generation, with the result that configuration of a network—in other words a black start—and line commutation of the current are made more difficult. Exemplary converters for island networks are the static traction converters in the decentralized traction power supply, where individual trolley wire sections are fed by in each case one single converter.

In all energy supply networks, the selective network protection is a fundamental prerequisite for safe network operation. If a short circuit arises in a power supply unit, this faulty power supply unit needs to be identified by the network protective devices and disconnected as rapidly as possible. In this case it is important that as few loads as possible are affected by the safety disconnection. Therefore, only as few operating means and loads as possible should always be disconnected from the voltage supply. A protective device identifies, for example, a fault in the subordinate power supply unit associated with it, by virtue of the fact that the current flowing into the power supply unit is above a previously set threshold value during a previously set minimum time period. This type of protection is referred to as overcurrent-time protection. If such an overcurrent condition is present, immediate disconnection of the subordinate faulty subnetwork via a circuit breaker is instigated by the protective device.

In the supply network, protective devices are used hierarchically for increasing the supply safety. If the protective device associated with the faulty power supply unit does not trigger a disconnection, the superordinate protective device, which monitors a plurality of power supply units, is triggered. For this purpose, its overcurrent-time protection is equipped with corresponding larger time and current threshold parameters. This is referred to as protective grading. If, first of all, the superordinate protective device trips, however, a plurality of power supply units are disconnected from the supply as the actually faulty power supply units. In addition to the overcurrent-time protection, there are also further types of protection, such as unbalanced load protection, differential protection, ground fault protection or the like, which can also be performed simultaneously by a protective device.

In large interconnected networks, the short-circuit current required for fault clearance is provided by the generators in the network. These are essentially synchronous machines. Rotating machines which are positioned electrically close, such as asynchronous machines which are connected directly to the network, for example, also make a contribution to the fault current. These motor loads may make a contribution to the fault current of up to five times their rated current.

A network fault generally leads to the network voltage for loads on the same busbar and in adjacent power supply units dipping for the duration of the fault. The regulation and control units of converters identify such a voltage dip owing to continuous measurement and evaluation of electrical measured variables such as network voltage and network currents and are usually disconnected. These network loads therefore generally do not make any contribution to the steady-state fault current.

If the network is produced merely by self-commutated converters, these converters on their own need to apply the fault current. Self-commutated converters function as controlled voltage sources, whose internal resistance is essentially determined by the reactance of the coupling inductor.

The current flowing from the feeding converter into the network is determined by the voltages generated and the limiting impedances between the converter connection terminals and the fault location. If the fault location is electrically close to the feed point, the coupling inductors on their own function in current-limiting fashion. In order to avoid protective disconnections of the converter itself, regulation of the converter therefore needs to be provided which instigates a change in the voltage system generated at the right time. This short period of time means, however, that the protective devices cannot identify the fault by means of the overcurrent-time protection. In this regard, a short-circuit current would be flowing over a substantially longer period of time.

In order to avoid a protective disconnection of the feeding converter and at the same time provide a maximum fault current for selective protective disconnection, the converter regulation needs to operate the feeding converter at a current limit, which is below the disconnection threshold of the converters but above the response threshold of the protective devices.

DE 41 15 856 A1 has disclosed a method for disconnecting an overcurrent in the case of an inverter. In order to reduce the voltage stress on the power semiconductors which are switching off, it is proposed that only one of two power semiconductors which are arranged in phase opposition and carry the overcurrent is switched off. This is expediently carried out such that one phase half is selectively disconnected once an overcurrent has been detected. In other words, either all of the semiconductor switches which are connected to the positive DC voltage connection or else all of the semiconductor switches which are connected to the negative DC voltage connection are selectively switched off, while the switching state of the remaining semiconductors remains unchanged.

The abovementioned method is associated with the disadvantage that, in particular in island network applications, the current is severely altered owing to the intervention and high current distortions occur.

One object of the invention is therefore to provide a method of the type mentioned at the outset with which converters at a DC voltage can be operated with little complexity and so as to generate less current distortion in the faulty network.

The invention solves this object by a method for regulating a converter, which is connected to a DC voltage source, with power semiconductor switches which can be switched off, which converter is provided for feeding a distribution network with three-phase voltage, in which method currents flowing through the respective power semiconductor switches are measured so as to obtain current values which are in each case associated with the power semiconductor switches, the current values are sampled and the sampled current values are digitized so as to obtain digital current values, and the digital current values are monitored by logic implemented in a regulation unit for the presence of an overcurrent condition, in the event of an overcurrent condition not being met, the power semiconductor switches being switched on and off with the aid of rated operation regulation and, in the event of the presence of an overcurrent condition, at least the power semiconductor switches being switched off which are subjected to digital current values which meet the overcurrent condition once a pulse inhibiting period has expired and, in the case of digital values which meet the overcurrent condition, all the power semiconductor switches which are connected to the positive DC voltage connection being switched on and all the power semiconductor switches which are connected to the negative DC voltage connection being switched off, or vice versa, and, in the case of digital current values which do not meet the overcurrent condition, the regulation of the power semiconductor switches again taking place by means of the rated operation regulation.

According to the invention, a method for regulating a converter in the event of a short circuit is provided. It is essential that the method according to the invention is part of the rated operation regulation and can therefore be implemented in existing regulation and control units. Within the context of the invention, it is therefore no longer necessary for separate hardware with a special short-circuit regulation method to be provided and for this to be coupled to existing control units.

According to the invention, the currents flowing through the power semiconductor switches are measured first. This takes place, for example, using converters, whose secondary connection produces a low voltage signal which is proportional to the current through the power semiconductor. Converters as such as are known, with the result that it is not necessary to provide further details at this point on their construction and operation. The output signal, which is proportional to the current through the respective power semiconductor, of the converter is sampled with a sampling clock so as to obtain sampling values, and the sampling values are converted into digital current values by means of an analog-to-digital converter and passed to the control unit for regulation of the converter. If an overcurrent condition is not established—if, for example, there is no short circuit—the power semiconductor switches are switched on and off, for example, by the pulse pattern of a pulse width modulation, i.e. with the aid of the rated operation regulation, which results in the desired transmission of active power and reactive power. If an overcurrent, for example, in the form of a short circuit, occurs, the logic of the control unit establishes that an overcurrent condition is present and instigates switching-off of at least of the power semiconductor switches which are subjected to the short-circuit current. It is thus possible, for example, for only the power semiconductor switches of the phase subjected to the overcurrent to be switched off. As a deviation from this, however, it is also possible to switch off all power semiconductor switches in all phases when an overcurrent is detected. The power semiconductor switch(es) remain(s) switched off throughout the pulse inhibiting period. Then, the power semiconductor switches which are connected to the positive DC voltage connection are switched on and all of the power semiconductor switches which are connected to the negative DC voltage connection are switched off. Alternatively to this, it is also possible, after the pulse inhibiting period, for all of the power semiconductor switches which are connected to the negative DC voltage connection to be switched on and, at the same time, for all of the power semiconductor switches which are connected to the positive DC voltage connection to be switched off. In other words, a zero-voltage indicator is realized according to the invention. This zero-voltage indicator brings about soft decay of the phase currents, in particular in the case of island networks. In this manner, a gradual reduction in the short-circuit current results until, finally, the overcurrent condition is no longer met. If the control and regulation unit establishes such an absence of the overcurrent condition, the regulation is changed over to the conventional rated operation regulation. For example, the pulse pattern of the regulation for normal operation is used. If the overcurrent condition is established once again, at least the power semiconductor switches which are subjected to the short-circuit current are switched off again, and the realization of a zero-current indicator then takes place and so on. The method according to the invention can be implemented in microcontrollers conventional on the market, which are used for regulating self-commutated low-voltage converters. The method according to the invention therefore has little complexity and allows for the selective disconnection of specific network regions in the event of short-circuit currents in the distribution network. High current distortions are avoided according to the invention.

Advantageously, the measured current values are sampled at a clock frequency of over 5 kHz. At such a sampling rate, a sufficiently rapid intervention of the method according to the invention is achieved in the case of overcurrents, for example short-circuit currents, with the result that undesirable current fluctuations, voltage peaks or the like are avoided even more effectively.

Expediently, the pulse inhibiting period is equal to the remaining pulse period of the power semiconductor switch(es) which is/are subjected to digital current values which meet the overcurrent condition. If a plurality of phases are subjected to overcurrents, the pulse inhibiting period is equal to the remaining pulse period. During the pulse inhibiting period, the relevant phase is provided with a pulse inhibitor. As a result, not only is a further current rise avoided, but, in contrast, the current is reduced.

Expediently, all the power semiconductor switches are switched off throughout the pulse inhibiting period. Switching all power semiconductor switches off simplifies regulation. Disadvantageous effects therefore do not occur.

Expediently, an overcurrent condition is present if the digital current values exceed a threshold value. The logic of the control unit compares the measured digital current values with the threshold value. If the current values are higher than the threshold value, an overcurrent condition is present. In one variant, an overcurrent condition is no longer present when the measured values fall below the threshold value.

As a deviation from this, it may be advantageous according to the invention for an overcurrent condition to no longer be present only when the digital current values fall below a second threshold value, the second threshold value being lower than the first threshold value. In this way, control takes place in accordance with a hysteresis.

Advantageously, in the event of the presence of an overcurrent condition, the desired amplitude of the three-phase voltage is reduced stepwise in comparison with the rated operation amplitude of the regulation which prevails during normal operation, and, in the event of subsequent elimination of the overcurrent condition, the desired amplitude of the three-phase voltage is increased stepwise. For this purpose, a reduction factor is introduced, for example, which is reduced successively from 1 to 0 in the event of the presence of an overcurrent condition. In the event of a subsequent elimination of the overcurrent condition, the voltage amplitude required by the regulation, i.e. the desired amplitude, is multiplied by the reduction factor. This is also referred to as reduction of the driving level. In the event of the elimination of the overcurrent condition, the reduction factor is again increased stepwise to 1. Here, a renewed overcurrent condition may result, such that the reduction factor is again successively reduced. As a deviation from this, in the event of an elimination of the overcurrent condition, the reduction factor is increased again slowly and thus the amplitude of the rated operation is achieved after sufficiently long-term elimination of the overcurrent condition. The reduction in the driving level of the rated operation regulation takes place in a significantly more pronounced manner than the creeping increase in the driving level after the presence of an overcurrent condition.

Expediently, the distribution network is an island network which has essentially no dedicated voltage source. However, the method according to the invention is also suitable for regulating converters which are connected on the AC-side to a distribution network, which has dedicated voltage sources, for example, in the form of generators.

Further expedient configurations and advantages of the invention are the subject matter of the description which follows relating to exemplary embodiments of the invention with reference to the figures in the drawing, in which the same reference symbols refer to functionally identical components, and in which

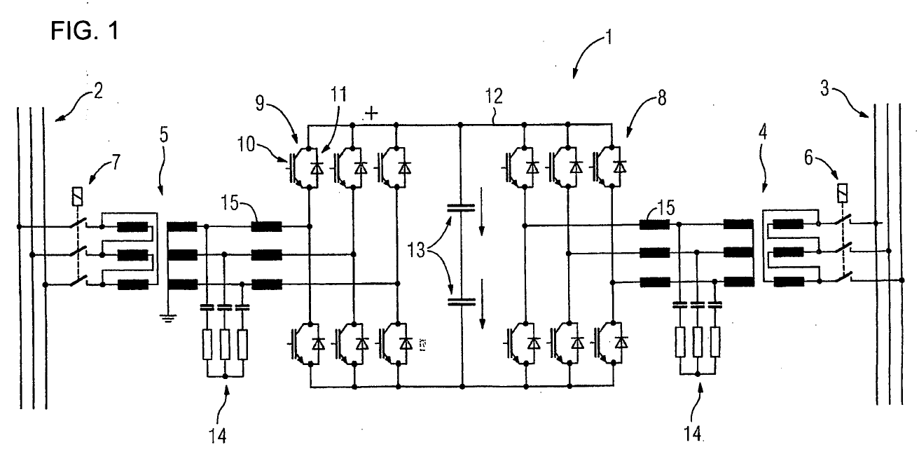

FIG. 1 shows the basic construction of a DC network coupling with self-commutated power semiconductor switches,

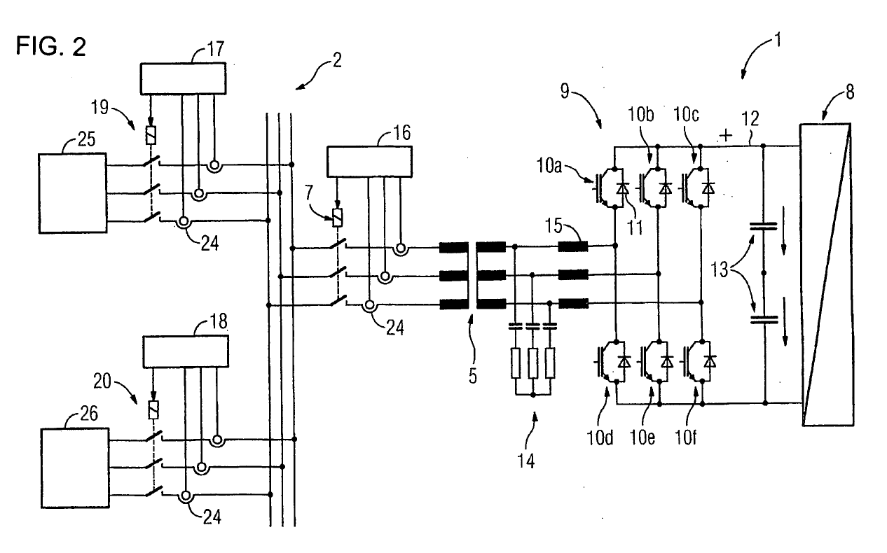

FIG. 2 shows the feeding converter of the DC network coupling shown in FIG. 1 and the distribution network, in this case realized as an island network, in a schematic illustration, and

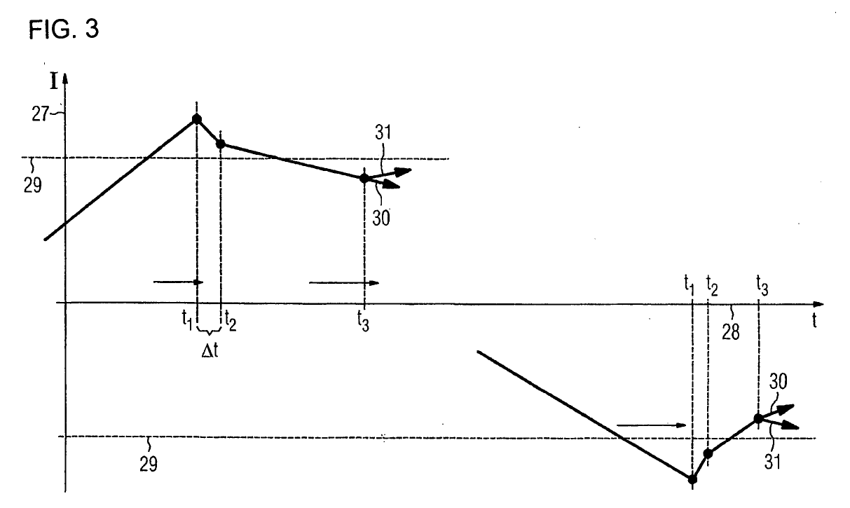

FIG. 3 shows the current profile of one phase of a converter as shown in FIG. 2, in a schematic illustration. FIG. 1 shows a DC network coupling 1 for supplying energy to an island network 2 by means of a supply network 3. The supply network 3 is connected to the HVDC bridge 1 via a transformer 4, and the island network 2 is connected to the HVDC bridge 1 by a transformer 5, the switches 6 and 7 being provided for decoupling the HVDC bridge 1 from the respective supply network 3 or from the island network 2.

The DC network coupling 1 has two converters 8 and 9 with self-commutated power semiconductor switches 10 in a 6-pulse bridge circuit. A freewheeling diode 11 is provided in the parallel circuit of each power semiconductor switch 10. The converters 8 and 9 are connected to one another via a DC voltage intermediate circuit 12, which forms a positive DC voltage connection provided with the “+” symbol and a negative DC voltage connection provided with the “−” symbol. Energy stores in the form of capacitors 13 are connected between the positive and negative connection of the DC voltage intermediate circuit 12.

In order to suppress harmonics, which occur on conversion of the current, filter banks 14 are provided which are each connected between the transformers 4, 5 and the converters 8 and 9, respectively, in a parallel circuit. Finally, inductances 15 are connected into each phase in order to provide a smooth current profile.

FIG. 2 shows the DC network coupling 1 shown in FIG. 1, in which the converter 8, which is provided for regulating the voltage in the DC intermediate circuit 12, is only illustrated schematically. In particular, this illustration shows protective devices 16, 17 and 18 which intervene in the energy distribution in a graded manner in terms of their operation and, for this purpose, each interact with a switch 7, 19 and 20, respectively. For current measurement purposes, converters 24 are provided which generate an output signal which is proportional to the respective phase and is sampled and digitized by the respective control unit 16, 17 or 18.

If a short-circuit current is present in a power supply unit region 25 of the island network 2, a short-circuit current fed by the converter 9 flows and is identified by means of the converter 24 both of the protective device 16 and the protective device 17. The protective devices are parameterized such that, initially, the protective device 17 responds and thus the subnetwork 25 is disconnected from the island network 2 via the switch 19 in a targeted manner without the power supply to the subnetwork 26 of the island network 2 being impaired. Once the subnetwork 25 has been disconnected a short circuit and thus disconnection of the entire island network 2 is avoided by the protective device 16. The protective device 16 merely has a safety function and intervenes when the protective device 17 does not trip even after a relatively long period of time, with the result that damage to sensitive components is avoided.

FIG. 3 illustrates one exemplary embodiment of the method according to the invention in a schematic illustration. The current flowing through one phase of the converter 9 in the event of a short circuit is plotted on the axis 27. The time axis is provided with the reference symbol 28. If the absolute value for the current in the phase shown exceeds a threshold value 29, the power semiconductor switches 10 associated with this phase are provided with a pulse inhibitor at time t1. In other words, the power semiconductor switches of the phase are switched off, or, in other words, the power semiconductors are changed over to their inhibiting position. After the end of the pulse inhibiting period, i.e. after the end of the pulse period of the phase, a zero-voltage indicator is generated at time t2 by all of the semiconductor switches 10a, 10b and 10c associated with the positive connection being switched on, the power semiconductor switches 10d, 10e and 10f, on the other hand, remaining switched off. In this manner, soft, gradual decay of the current results, such that severe current fluctuations in the island network 2 are avoided. At time t3, the regulation is taken on by the rated operation regulation, but with a lower driving level. If the subnetwork unit having the short circuit has been removed successfully from the network by means of the protection technique, the current changes over to its rated value owing to the resultant driving level, as is illustrated by the lower arrow 30. If, furthermore, a short circuit is present, the current again rises to above the threshold value 29, as indicated by the arrow 31, with the result that the abovedescribed method is carried out again. Corresponding regulation for negative alternating currents is likewise indicated in FIG. 3.

1-7. (canceled)

8. A method of regulating a converter, which is connected to a DC voltage source with a positive DC voltage connection, a negative DC voltage connection, and with power semiconductor switches, the method which comprises:
operating the converter to feed a distribution network with a three-phase voltage;
measuring currents flowing through the power semiconductor switches to acquire current values each associated with a respective power semiconductor switch;
sampling the current values and digitizing the sampled current values to obtain digital current values;
monitoring the digital current values by logic implemented in a closed-loop control unit for an overcurrent condition, and
if an overcurrent condition is not met, switching the power semiconductor switches on and off in accordance with a rated operation regulation;
if an overcurrent condition is detected, switching off at least the power semiconductor switches that are subject to digital current values meeting the overcurrent condition,
after a pulse inhibiting period has expired and in the case of digital values that meet the overcurrent condition, switching on the power semiconductor switches connected to the positive DC voltage connection and switching off the power semiconductor switches connected to the negative DC voltage connection, or vice versa; and
in the case of digital current values that do not meet the overcurrent condition, once more controlling the power semiconductor switches by way of the rated operation regulation.

9. The method according to claim 8, which comprises sampling the measured current values at a clock frequency of over 5 kilohertz.

10. The method according to claim 8, which comprises setting the pulse inhibiting period equal to a remaining pulse period of the power semiconductor switch or switches subject to digital current values meeting the overcurrent condition.

11. The method according to claim 8, which comprises switching off all the power semiconductor switches throughout the pulse inhibiting period.

12. The method according to claim 8, which comprises defining an overcurrent condition if a digital current value exceeds a upper threshold value.

13. The method according to claim 12, which comprises deciding that an overcurrent condition is no longer present only when the digital current values fall below a lower threshold value, the lower threshold value being lower than the upper threshold value.

14. The method according to claim 8, which comprises, if the presence of an overcurrent condition is determined, reducing a setpoint amplitude of the three-phase voltage stepwise in comparison with an amplitude during the rated operation regulation during normal operation, and, upon a subsequent elimination of the overcurrent condition, increasing the setpoint amplitude of the three-phase voltage stepwise.
